(19) United States
(12) Patent Application Publication
(10) Pub. No.: US 2025/0327535 A1
(43) Pub. Date: Oct. 23, 2025

(54) Hydronic Heating/ Cooling Ceiling Plates

(71) Applicants: RUBEN GARZA, SAN MATEO, CA (US); DANIEL GARZA, HAYWARD, CA (US); JULIAN GARZA, STOCKTON, CA (US)

(72) Inventors: RUBEN GARZA, SAN MATEO, CA (US); DANIEL GARZA, HAYWARD, CA (US); JULIAN GARZA, STOCKTON, CA (US)

(21) Appl. No.: 18/644,078

(22) Filed: Apr. 23, 2024

(51) Int. Cl. F16L 3/04; F24D 3/16

(52) U.S. Cl. CPC F16L 3/04; F24D 3/16

(57) ABSTRACT

Adhering Hydronic Heating/Cooling Ceiling Plates directly to Sheet Rock and installing the system in an attic is new because of location and adhesion technology. Antiquated systems could not be mounted directly to sheathing due to the lack of an attachment method. Installation of plates in the attic was problematic due to inefficient mounting and noise.

Major accomplishments include a custom holes design at strategic intervals in each apparatus allowing construction cement to rise above the plate surface when applied directly to sheetrock in attic side of ceilings and pressed from top of plate apparatus. Inherently forming a flexible bond to the Sheet Rock at tactical locations reducing or eliminating noise plaguing older designs.

### FIELD

The purpose of this application is to patent protect customized aluminum plates that are designed by Ruben Garza for Alternative Energy and Heating Solutions. The plate apparatus adhere directly to ceiling sheathing via attic accessible living spaces or interstitial spaces of single family or multi dwelling homes.

### BACKGROUND

Typical Radiant/Hydronic Heating Plates are mounted directly to a subfloor, wall or ceiling. Plates are made with heat transferable material to disperse or radiate the temperature of water inside PEX tubing running longwise between rafters, each plate is mounted adjacently. Each plate contains a hump or half radius bulge high enough to except the Radiant PEX tubing used in construction, typically ½″ for residential housing.

### SUMMARY

Hydronic Heating/Cooling Ceiling plates are designed to transfer heated or chilled water circulated through PEX tubing installed in ceilings via the attic of single-story homes or interstitial of multiple story living spaces.

By providing an innovative mounting technology that will reduce noise, increase BTU transfer, and directly adhere Hydronic Heating/Cooling Plates to existing Sheet Rock, the disclosed technology will provide an economic substitute for forced Air HVAC systems and High End Radiant/Hydronic systems.

Further features and advantages of Hydronic Heating/Cooling Ceiling Plate apparatus include a move toward the Electrification of Households. Mounting of Hydronic piping through the entire living space via the attic or interstitial space allows the complete system to be zoned and controlled by indoor thermostats in each living space.

Hydronic systems also eliminate the transfer of toxins through ducting in the typical forced air systems.

The Energy Cost savings gained through Radiation of Energy our custom Hydronic Heating/Cooling Ceiling Plate Systems will vary by climate regions and insulation technics designed by installing contractors.

### REFERENCE TO DRAWINGS

FIG. 1 shows an Isometric Top view of a Straight Plate design and location of holes (Figure3) drilled into plates for adhesion.

FIG. 2 is an end-view of the Straight Plate design showing a one-inch Hump pressed into the aluminum sheet where Radiant PEX tubing will track.

FIG. 3 shows number and size of strategic adhesion holes drilled into each plate apparatus. Strategic adhesion holes consist of one ⅜″ hole in the center and four ¼″ holes at each quadrant surrounding center hole.

FIG. 4 shows an Isometric Top view of an End Plate design and location of holes (FIG. 5) drilled into plates for adhesion.

FIG. 5 is an Isometric view of the End plate with two one-inch Humps pressed into the aluminum sheet where PEX tubing will track.

FIG. 6 shows the amount and size of adhesion holes. Strategic adhesion holes consist of one ⅜″ hole in the center and four ¼″ holes at each quadrant surrounding center hole.

### DETAILED DESCRIPTION

The design of Hydronic Heating/Cooling Ceiling Plates is commensurate to Radiant Heating plates used for Hydronic heating or cooling systems.

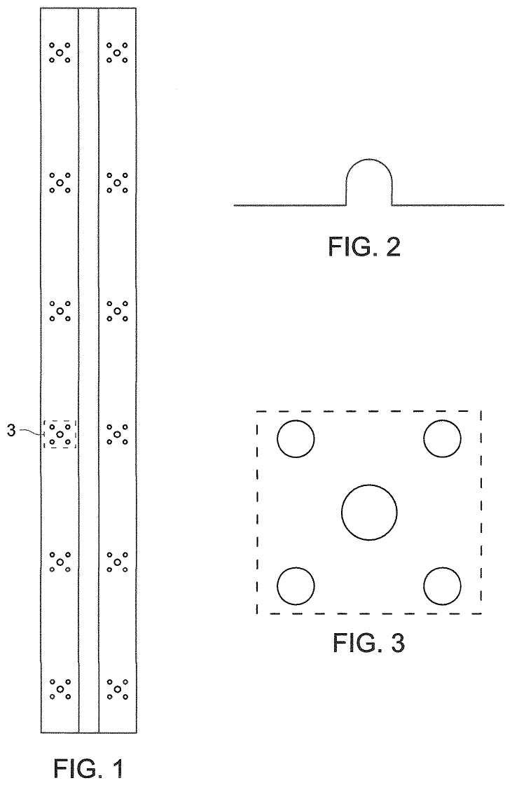

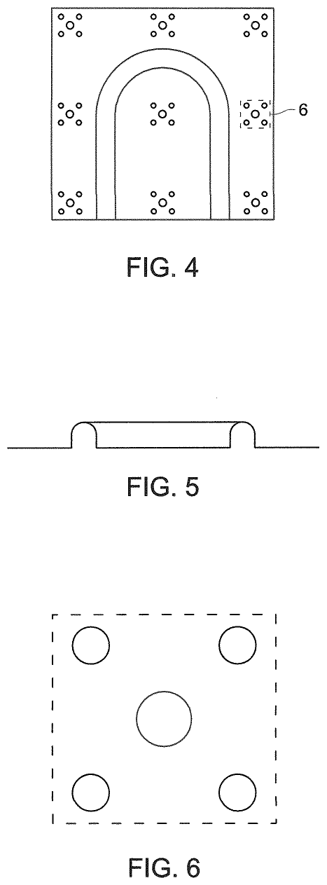

FIG. 1 apparatus is a Straight plate design with custom mounting holes (FIG. 3) drilled at strategic locations along the plate. Each apparatus run end-to-end between ceiling rafters before returning back through the rafter space via End Plate Design (FIG. 4); approximately 3′ from the outer wall or end of rafter. End plate design will have mounting holes (FIG. 6) at tactical locations to account for PEX expansion or contraction.

The plate adhesion holes (FIGS. 3 & 6) will allow construction cement to rise above the plate surface when applied directly to sheetrock and pressed; becoming a secure fastener when dried. The amount of cement protruding shall be no less than one-half inch.

### Background of Discovery

1. In the HVAC field radiant heat plates are used in commercial and residential construction of Hydronic systems to heat or cool floors, ceilings or walls.

2. Existing Systems

Existing Hydronic Heating/Cooling applications require mounting plates and Radiant PEX tubing to be screwed into subfloors between rafters or through existing sheetrock inside living spaces. Alternatively installing High-End customed designed panels that accommodate Radiant PEX. Afterward adding a new layer of sheathing to cover plates and PEX tubing. A method which is labor and material cost prohibiting for lower and mid income households.

1. Using Hydronic Heating Cooling plate apparatus will require installation of a Hydronic air to water Heat Pump(s) depending upon the total Sqft. of living space.
Wherein heated or chilled water will be pumped away from Heat Pump in Claim #1 into PEX tubing and radiated into living space via Straight and Curved apparatus FIG. 1 or FIG. 1 accordingly.
Wherein aluminum plate apparatus will distribute heated or cooled PEX tubing installed in ceilings between joists via the Attic of single-story homes or Interstitial of multiple story living spaces radiating Heat or Cooled air convection.
Wherein Straight aluminum Apparatus FIG. 1 are pressed one-inch high in the middle to accommodate half inch Hydronic PEX tubing.
Wherein End Plate Apparatus are pressed one-inch high in a curvature to accommodate return of PEX tubing through ceiling joist.

2. Each plate apparatus will entail an innovative adhesion technology that will reduce noise, increase BTU transfer, and directly adhere plates to existing Sheet Rock.
Wherein adhering each plate apparatus to ceiling sheathing supersedes existing forms of Hydronic Heat plate designs stapled underfloor, suspended between joists or mounted inside living space to existing Sheathing; requiring installation of an additional sheet of Sheet Rock covering.

3. Using apparatus #1 and apparatus #4 Hydronic Heating/Cooling plates will reduce Heat Loss and increase Energy Savings.
Wherein savings gained through Radiation and Convection of tempered Energy directly to sheathing via Hydronic Heating/Cooling Ceiling plates will vary by climate regions and insulation technics designed by installing contractors.
Wherein consumers are provided an option to install a forced air HVAC system, ductwork and associated labor.
Wherein Hydronic systems eliminate the transfer of toxins through ducting required in HVAC systems, no ducting is necessary therefore toxin bearing forced air is eliminated.

4. Using felt at each apparatus intersection will compensate for noise and any condensation that may develop during cooling mode.
Wherein movement along adjacent apparatus intersection is reduced or eliminated.

5. Strategic holes (FIG. 3 and 6) in each apparatus design (FIG. 1 and 4) will allow construction cement to rise above plate and adhere apparatus directly to sheetrock when pressed and allowed to dry.
Wherein construction cement allows flexibility of plate apparatus reducing infiltration of air into PEX cavity reducing condensation during cooling.
